(19) United States
(12) Patent Application Publication
(10) Pub. No.: US 2005/0015981 A1
(43) Pub. Date: Jan. 27, 2005

(54) Caliper piston retractor tool

(76) Inventors: David P. Walters, Morgan, GA (US); William G. Cox, Albany, GA (US)

Correspondence Address: Mr. Walter J. Tencza Jr., Suite 3, 10 Station Place, Metuchen, NJ, 08840, US

(21) Appl. No.: 10/683,678

(22) Filed: Oct. 10, 2003

Related U.S. Application Data
(63) Continuation-in-part of application No. 10/623,301, filed on Jul. 18, 2003.

(51) Int. Cl. B25B 27/00; B23P 11/00

(52) U.S. Cl. 29/888.011; 29/270

(57) ABSTRACT

An apparatus and a method are provided for pushing back caliper pistons, such as for example, single, double or quadruple caliper pistons. The apparatus may be comprised of a first rod, a second rod, and a third rod. The first rod may be connected to the second and third rods so that when the first rod moves the second and third rods also move. The apparatus may also include a first plate, wherein the first rod, the second rod, and the third rod are connected to the first plate. The apparatus may further include a second or press plate, which is connected to the second rod and the third rod. The apparatus may further include a third or tube plate and a fourth or wedge plate. The second and third rods may slide through first and second openings of the third and fourth plates.

### CROSS REFERENCE TO RELATED APPLICATION(S)

The present application is a continuation in part of and claims the priority of parent patent application Ser. No. 10/623,301, titled “CALIPER PISTON RETRACTOR TOOL”, filed on Jul. 18, 2003, inventor and applicant(s) David P. Walters and William G. Cox.

### FIELD OF THE INVENTION

This invention relates to pressing back disc brake caliper pistons, which are found in the majority of automobiles and pickup trucks, particularly during brake pad replacement.

### BACKGROUND OF THE INVENTION

Prior tools have been designed for pushing back caliper pistons after disc brake pads are replaced. U.S. Pat. No. 6,523,238 to Priddy, incorporated by reference herein, shows an example of a brake caliper depressor device of the prior art. Priddy discloses a depressor device 10 comprised of a gun assembly 11. (Priddy, col. 3, Ins. 47-55). A user places an abutment member 29 against a brake caliper 42 and places a caliper piston engagement member 38 against a caliper piston or pistons and pulls on a lever 27 to urge a push rod member 34 towards the caliper piston or pistons to force the caliper pistons back into place after having replaced the disc brake pads. (Priddy, col. 4, Ins. 36-45). Once finished the user presses on the curved second portion 33 of the push rod release member 31 to allow the spring 30 to release the push rod member 34. This technique is undesirable because it cannot apply equal pressure in a single action across multiple piston calipers to include double and quad piston calipers.

The tool disclosed in Priddy is not designed for pressing double or quad piston calipers. The scope of use is very limited as most of today's automobiles and pickup trucks are manufactured with single, double and quad piston calipers. The durability of construction of the tool disclosed in Priddy would not withstand the day-to-day use in most automotive shops and due to the design, it would be difficult to repair the tool.

In order to make the member 38 in Priddy retract to its original position one must depress the curved portion 33 of the push rod release member 31 with one hand and pull back on the rod 37 with a second hand. This can be difficult as the operator must release the caliper with one hand in order to pull back handle 37.

During a new brake pad installation, the caliper is unbolted from the rotor and hub assembly and lifted off of the rotor in order to remove the old brake pads. The brake hose that supplies hydraulic fluid to the caliper is left attached to the caliper. The caliper is then placed or rested on top of the rotor and hub assembly in an unbolted state and generally held or stabilized with one hand by the technician. Since the Priddy tool of the prior art requires two hands, i.e. one hand to depress the curved portion 33 and one hand to pull back on the rod 37, this leaves the caliper unsecured with nothing but a brake hose to stop it should it be dislodged. This is dangerous.

The single long push rod 34 of Priddy limits the strength of the force applied to the caliper piston. The Priddy long single push rod design basically makes this tool susceptible to bending or warping of the push rod 34 when applying pressure. The tool in Priddy cannot apply equal pressure to the pistons in dual and quad piston applications.

### SUMMARY OF THE INVENTION

In the present invention in one or more embodiments a double push rod is provided and a push plate to push caliper pistons. The double push rod and push plate design applies substantially equal pressure across a surface of the push plate. A short single rod is used to push the double rod. The short single rod has much greater rigidity than the longer rod design of the prior art.

The present invention in one or more embodiments provides a caliper piston retractor tool, which can press back double, single, and quad caliper pistons. In one embodiment the tool takes a single shaft or single push rod and converts it to a two shaft or double push rod that screws into a specially designed and tested push or press plate. The push plate and a wedge plate are designed to fit the majority of all domestic and imported passenger automobile and pickup truck calipers on the market today. The tool or apparatus, in one embodiment, has a handle, which when squeezed causes the single push rod to push the pair of, or double push rods, forward. Holding the tool so that the longest side of the plates are perpendicular with respect to ground adapts the tools to press back single piston calipers as in FIGS. 6B-6C. Holding the tool so that the plates are horizontal adapts the tool to pressing back double piston calipers as in FIGS. 7B-7C.

Quad piston calipers can be pressed holding the tool in either position depending on the piston arrangement.

A tool or apparatus in accordance with the present invention easily pushes single pistons, double pistons, and most quad piston designs back to their original positions in the caliper in one application saving a great deal of time for brake technicians. When the piston is back in the caliper, the technician presses a spring loaded quick release trigger and the press plate springs back to its starting position.

In one embodiment an apparatus is provided comprising a first or single rod, a second rod, and a third rod. The second and the third rods may be called a double rod. The first rod may be connected to the second and third rods so that when the first rod moves the second and third rods also move. The apparatus may also include a first or cam plate, wherein the first rod, the second rod, and the third rod are connected to the first plate. The apparatus may further include a second or press plate, which is connected to the second rod and the third rod.

The apparatus may further include a third or tube plate and a fourth or wedge plate. The second and third rods may slide through first and second openings of the third and fourth plates. First and second spacers may be provided which space the third and fourth plates a fixed distance away from each other.

A tube housing and a handle assembly may be provided. Fourth, fifth, and sixth rods, or handle attachment bolts may connect the second or tube plate to the handle assembly. The handle assembly may be connected to the first rod so that when a part of the handle assembly is squeezed the first rod moves in a first direction to cause the second and the third rods to move also in the first direction. A first and a second spring may also be provided through which the second and the third rod, respectively, may be inserted.

The handle assembly may include a trigger release device, which if activated after the first rod has moved in the first direction causes the first rod to move in a second direction, which is opposite the first direction.

The present invention also provides a method comprising placing an apparatus in a first state, placing the apparatus onto a caliper piston of an automobile, pressing back the caliper piston with the apparatus, and removing the apparatus from the caliper piston. The apparatus used for the method may be an apparatus as previously described. The caliper piston may be, for example, a single or a double caliper piston.

Unlike the prior art tool in Priddy, with an apparatus or tool of one or more embodiments of the present invention, once the caliper is stabilized with one hand, the other hand has complete control over the tool of the present invention to press the caliper pistons back. The technician then presses the quick release trigger and the tool returns to its starting position. The technician does not have to release the caliper being stabilized with one hand and reach to pull the shaft or single rod back on the tool. The one hand operation and quick release return of the tool of the present invention is a significant advantage in speed and safety over the prior art.

### BRIEF DESCRIPTION OF THE DRAWINGS

FIG. 1 shows a perspective view of an apparatus in accordance with an embodiment of the present invention wherein the apparatus has been taken apart;

FIG. 2 shows a perspective view of part of the apparatus of FIG. 1, shown taken apart further;

FIG. 3 shows a perspective view of the apparatus of FIG. 1 wherein the apparatus has been assembled and placed in a first state;

FIG. 4 shows a perspective view of the apparatus of FIG. 1 wherein the apparatus has been assembled and placed in a second state;

FIG. 5 shows a front view of a push rod, handle assembly, and tube cap, which are part of the apparatus of FIG. 1;

FIG. 6A shows a perspective view of an apparatus including a caliper housing (or brake housing) and a single piston;

FIG. 6B shows a perspective view of the apparatus of FIGS. 1-5 in the state of FIG. 3, inserted into the caliper housing of FIG. 6A;

FIG. 6C shows a perspective view of the apparatus of FIGS. 1-5 in the state of FIG. 4, inserted into the caliper housing of FIG. 6A;

FIG. 7A shows a perspective view of an apparatus including a caliper housing and a double piston or double caliper piston;

FIG. 7B shows a perspective view of the apparatus of FIGS. 1-5 in the state of FIG. 3 inserted into the caliper housing of FIG. 7A;

FIG. 7C shows a perspective view of the apparatus of FIGS. 1-5 in the state of FIG. 4 inserted into the caliper housing of FIG. 7A;

FIG. 8 shows a perspective view of the apparatus of FIGS. 1-5 in the state of FIG. 4, inserted into a quadruple caliper piston;

FIG. 9 shows a perspective view of another apparatus in accordance with an embodiment of the present invention, wherein the apparatus has been, at least partially, taken apart;

FIG. 10, shows a perspective view of the apparatus of FIG. 9, wherein the apparatus has been assembled and has been placed in a first or compressed state;

FIG. 11 shows a perspective view of the apparatus of FIG. 9, wherein the apparatus has been assembled and has been placed in a second or expanded state;

FIG. 12 shows a front view of a push rod and a handle assembly, which are part of the apparatus of FIG. 1;

FIG. 13A shows a perspective view of the apparatus of FIGS. 9-12 in the state of FIG. 10, inserted into the caliper housing of FIG. 6A;

FIG. 13B shows a perspective view of the apparatus of FIGS. 9-12 in the state of FIG. 11, inserted into the caliper housing of FIG. 6A;

FIG. 14A shows a perspective view of the apparatus of FIGS. 9-12 in the state of FIG. 10 inserted into the caliper housing of FIG. 7A;

FIG. 14B shows a perspective view of the apparatus of FIGS. 9-12 in the state of FIG. 11 inserted into the caliper housing of FIG. 7A; and

FIG. 15 shows a perspective view of the apparatus of FIGS. 9-12 in the state of FIG. 11, inserted into a quadruple caliper piston.

### DETAILED DESCRIPTION OF THE DRAWINGS

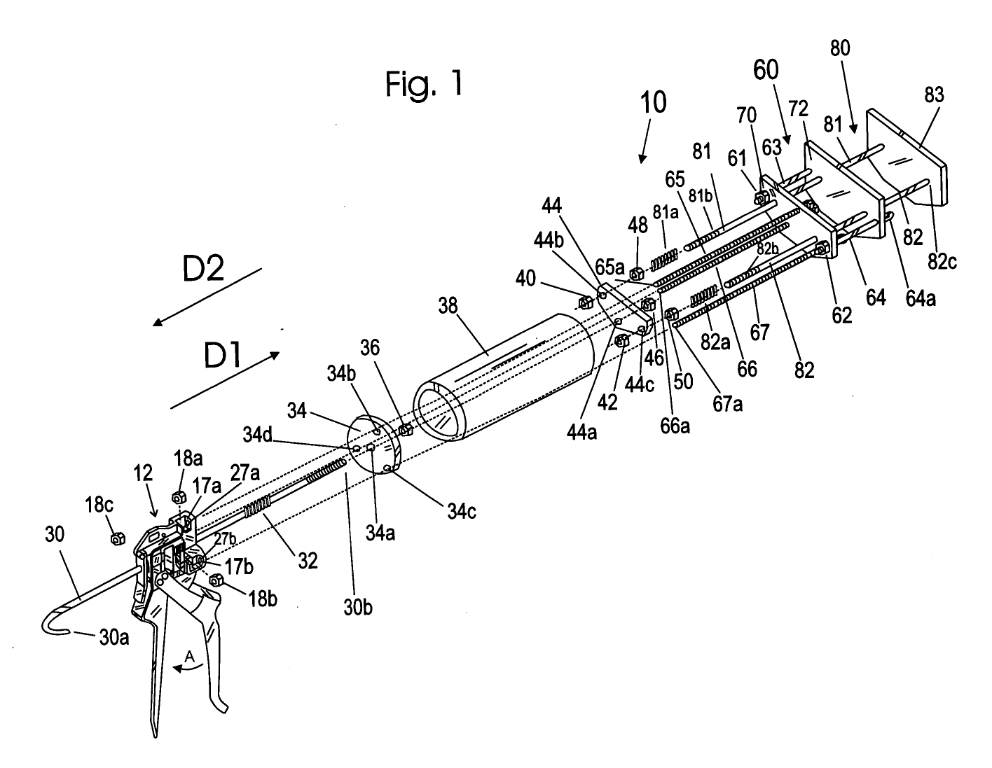

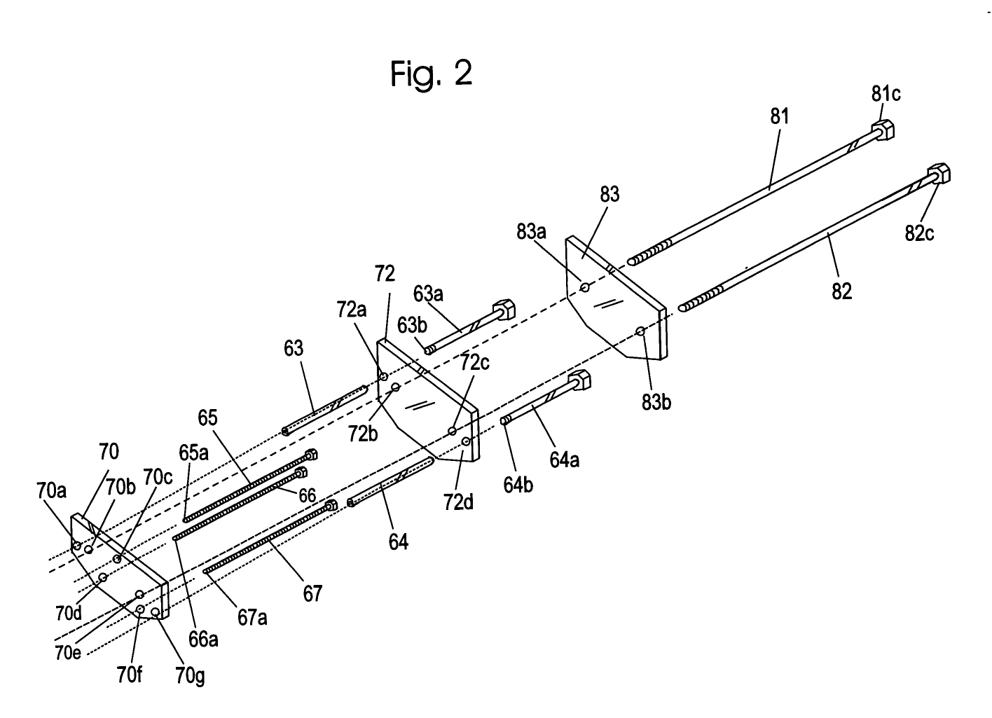

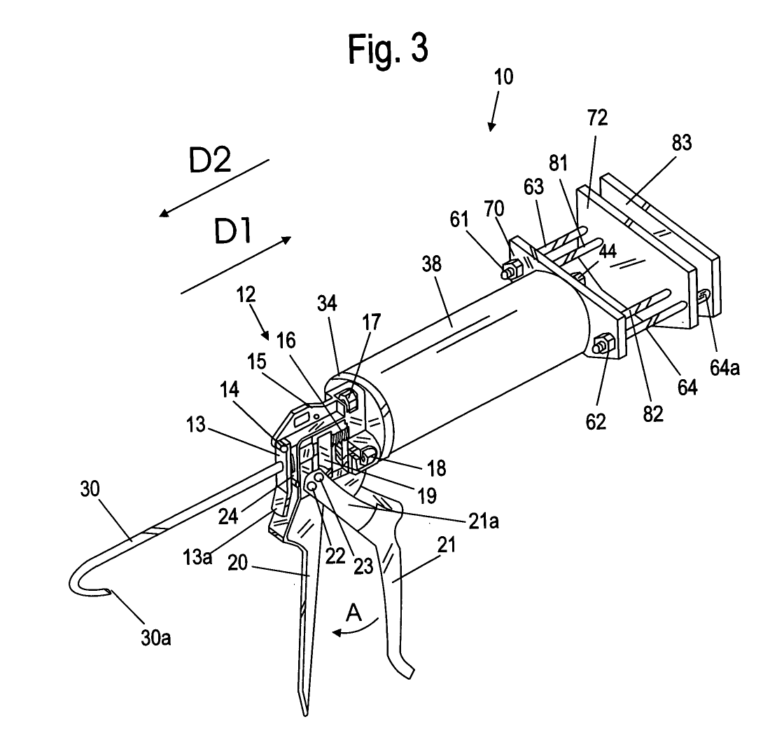

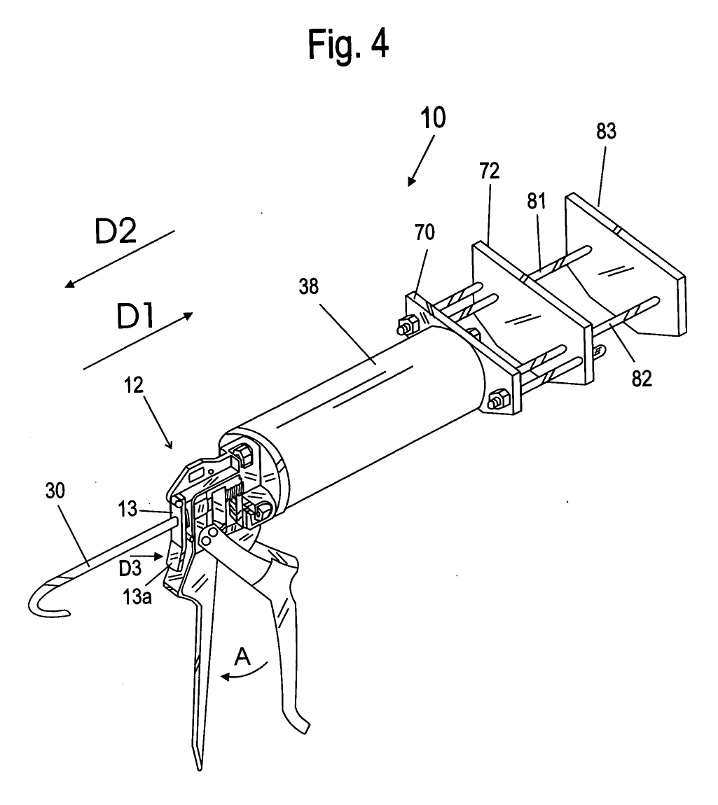

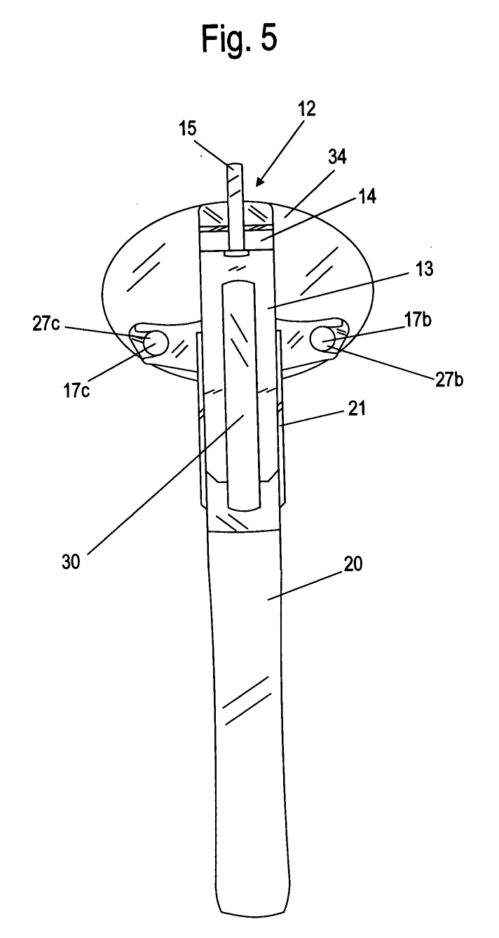

FIG. 1 shows a perspective view of an apparatus 10 in accordance with an embodiment of the present invention wherein the apparatus 10 has been taken apart. FIG. 2 shows a perspective view of part of the apparatus 10 of FIG. 1, shown taken apart further. FIG. 3 shows a perspective view of the apparatus 10 of FIG. 1 wherein the apparatus 10 has been assembled and placed in a first state. FIG. 4 shows a perspective view of the apparatus 10 of FIG. 1 wherein the apparatus 10 has been assembled and placed in a second state. FIG. 5 shows a front view of a push rod, handle assembly, and tube cap, which are part of the apparatus 10 of FIG. 1.

Referring to FIG. 1, the apparatus 10 is comprised of a push rod 30, a handle assembly 12, a tube cap 34, a tube housing 38, a cam plate or member plate 44, a spacer assembly 60, and a push plate assembly 80.

The push rod 30 has included thereon a spring 32. The push rod 30 ends in a loop at end 30a and has threads at end 30b.

The handle assembly 12 is shown in further detail in FIGS. 3 and 5. The handle assembly 12 includes release trigger lever 13, member 14, member 15, spring 16, and pockets or seats 17a, 17b, and 17c (shown by FIGS. 1 and 5), into which nuts 18a, 18b, and 18c shown in FIG. 1, can be inserted. The handle assembly 12 also includes rod driver 19, stationary handle 20, and pull handle or portion 21, pivot pin 22, restraining pin 23, and spring 24.

Referring to FIGS. 1 and 2, the spacer assembly 60 includes a tube plate 70, a wedge plate 72, handle attachment bolts 65, 66, and 67, spacer nuts 61 and 62, spacers 63 and 64, and spacer bolts 63a and 64a. The push plate assembly 80 includes push plate 83, push rods 81 and 82. The push plate assembly 80 also includes springs 81a and 82a through which rods 81 and 82 are inserted. The push rods 81 and 82 have threads at ends 81b and 82b. The push rods 81 and 82 are fixed to the push plate at ends 81c and 82c.

The apparatus 10 can be assembled in the following manner. The spacer assembly 60 can be assembled by first inserting ends 65a, 66a, and 67a, of threaded attachment bolts 65, 66, and 67, respectively, through openings 70c, 70d, and 70f, respectively, of the tube plate 70, as shown by FIG. 2. Each of the other ends of bolts 65, 66, and 67 may have a typical hex bolt head as shown by FIG. 2.

Next, referring to FIG. 2, threaded ends 63b and 64b of spacer bolts 63a and 64a, respectively, can be inserted through holes 72a and 72d, respectively, of the wedge plate 72. The spacer bolts 63a and 64a can then be inserted through spacers 63 and 64, respectively, and through holes 70a and 70g, respectively, of the tube plate 70. Nuts 61 and 62 can then be screwed onto the threaded ends 63b and 64b of the spacer bolts 63a and 64a, respectively, to fix the tube plate 70 to the wedge plate 72.

Next, the push plate 83 is fixed to ends 81c and 82c of the push rods 81 and 82, respectively. The ends 81c and 82c may be threaded and may be fixed to the push plate 83 by screwing the push rods 81 and 82 into threaded openings 83a and 83b, respectively. Ends 81b and 82b of the push rods 81 and 82, respectively, may then be inserted into and through the openings 72b and 72c of the wedge plate 72, respectively. Ends 81b and 82b of the push rods 81 and 82, respectively, may next be inserted into and through the openings 70b and 70e, respectively of the tube plate 70. Ends 81b and 82b may then be inserted through springs 81a and 82a, as shown in FIG. 1, then screwed into and through nuts 48 and 50, then inserted into openings 44b and 44c of cam plate 44 and then screwed into and secured to nuts 40 and 42 respectively. In this configuration, the cam plate 44 is fixed to the push rods 81 and 82 so that when the cam plate 44 moves in th direction D1 or D2, shown in FIGS. 1, 3, and 4, the push rods 81 and 82 will also move. When the cam plate 44 moves in the direction D1 or D2, the push rods 81 and 82 will slide through the openings 70b and 70e of the tube plate 70, and through the openings 72b and 72c of the wedge plate 72, respectively. However, when the cam plate 44 moves in the direction D1 or D2 the push rods 81 and 82 will move the push plate 83 in the direction D1 or D2.

Next, the cam plate 44, ends 81b and 82b of the push rods 81 and 82, respectively, and ends 65a, 66a, and 67a of the handle attachment bolts 65, 66, and 67, respectively, may be inserted into the tube housing 38. Threaded end 30b of the push rod 30, shown in FIG. 1, is then inserted into and through the central opening 34a of the tube cap 34. A nut 36, such as a lock nut, is then screwed onto the end 30b until the end 30b comes through the nut 36. The end 30b of the push rod 30 is then inserted into and through tube housing 38 and then into and through the central opening 44a of the cam plate 44. A lock nut 46 is then screwed onto the end 30b so that the end 30b is fixed to the cam plate 44. The push rod 30 can then slide through opening 34a in the tube cap 34 but is fixed to the cam plate 44 so that when the push rod 30 slides in the direction D1 or D2, the cam plate 44 also moves in the direction D1 or D2.

Ends 65a, 66a, and 67a of the handle attachment bolts 65, 66, and 67 are next inserted through the openings 34b, 34d, and 34c, respectively, of the tube cap 34. Nuts 18a, 18b, and 18c are inserted into the seats or pockets 17a, 17b, and 17c. The ends 65a, 66a, and 67a are next inserted through pocket or seat openings 27a, 27b, and 27c, respectively, in the handle assembly 12 and screwed into nuts 18a, 18b, and 18c, respectively, to secure the handle attachment bolts 65, 66, and 67, to the handle assembly 12. This results in the handle assembly 12 pressing against the tube cap 34, the tube cap 34 pressing against tube housing 38, and the tube housing 38 pressing against the tube plate 70 as shown by FIGS. 3 and 4.

After the apparatus 10 has been assembled, as in FIG. 3 or FIG. 4, the apparatus 10 can be placed in either the state of FIG. 3 or FIG. 4. As known in the art, when disc brake calipers are removed from a rotor, the static hydraulic pressure in the brake system forces the caliper pistons outward. This makes it impossible to install new disc brake pads in the caliper and fit the caliper assembly over the rotor; without retracting the caliper pistons first. In accordance with an embodiment of the present invention, the apparatus 10 can be used for the purpose of retracting single, double, or quadruple caliper pistons.

The apparatus 10 would typically be first placed in the state shown in FIG. 3 where the press plate 83 is pressing against or closely adjacent to the hex heads of the spacer bolts 63a and 64a. The press plate 83 can gradually be forced to move in a direction D1 away from the wedge plate 72, from the position or state of FIG. 3 to the position or state of FIG. 4, by squeezing portion 21 of the handle assembly 12, to make portion 21 pivot toward, in a direction A, toward portion 20. The portion 21 pivots about axis or pin 22. The squeezing and/or pivoting of portion 21 causes top portion 21a, shown in FIG. 3, to deflect and push portion 19. Portion 19, in response, frictionally grips onto push rod 30 and pushes push rod 30 forward in the direction D1. With each squeeze or pivot of the portion 21, the push rod 30 moves in the direction D1 causing the push plate 83 to also move in the direction D1. The push rod 30 can be moved in the direction D1 with each pivot of the portion 21 in the direction A shown in FIG. 3, until the end 30b of the push rod 30 comes in contact with the tube plate 70. At that time, the apparatus 10 is in its fully extended state, shown in FIG. 4.

The apparatus 10 can be easily changed from the state in FIG. 4 back to the state in FIG. 3, by pressing on portion 13a, shown in FIGS. 3 and 4, of the release trigger 13 in the direction D3, shown in FIG. 4. Pressing on portion 13a of the release trigger 13 presses on spring 24 of the handle assembly 12, causing push rod 30 to be released from being restrained by spring 24, and as a result causes push rod 30 to slide back into the position or state of FIG. 3. When the push rod 30 moves in the direction D1, the cam plate 44 and the push rods 81 and 82 also move in the direction D1. When this occurs the cam plate 44 compresses the springs 81a and 82a located on the push rods 81 and 82, causing the springs 81a and 82a to exert a force on the cam plate 44 and thus on the push rod 30 in the direction D2. However, the spring 24 exerts a force in the direction D1 to counteract the force of the springs 81a and 82a. When the portion 13a on the release trigger 13 is pressed, it releases the spring 24, so that the spring 24 no longer frictionally exerts a force in the direction D1. With the spring 24 no longer providing a force in the direction D1, the force provided by the springs 81a and 82a in the direction D2 pushes the cam plate 44, the push rod 30, and the push rods 81 and 82 back to the position of FIG. 3. Spring 16 is a spring, which applies pressure in the direction of D2 to the rod driver 19. This holds the rod driver 19 in place until one squeezes the pull handle or portion 21 again.

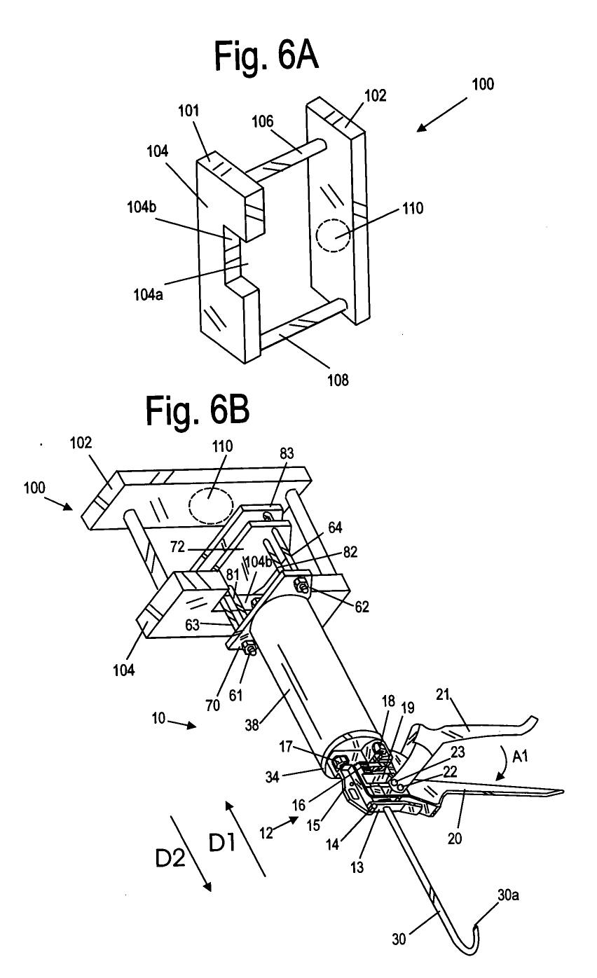

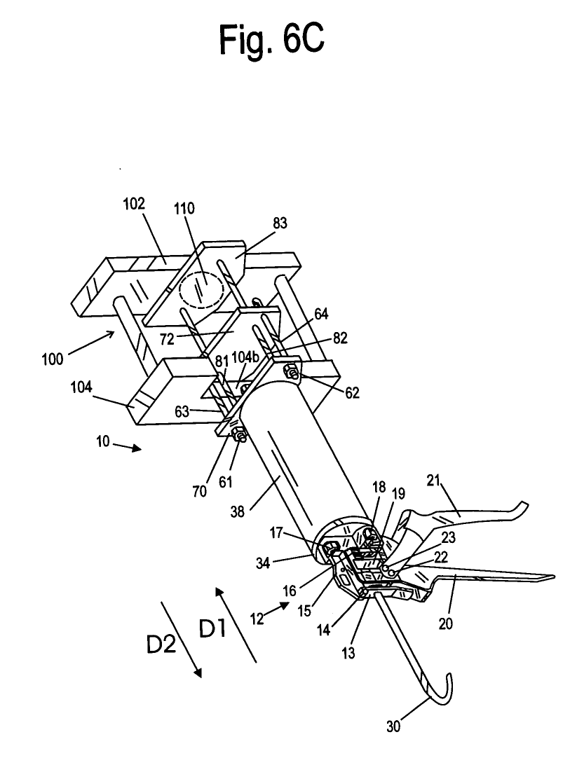

FIG. 6A shows a perspective view of an apparatus or caliper 100 including a caliper housing 101 comprised of portions 102 and 104 (or brake housing) and a single piston 110. The portion 102 of the housing is connected to the portion 104 by members 106 and 108. The portion 104 has a U-shaped slot 104a which has a bottom 104b.

In FIG. 6A, members 106 and 108 represent the steel sides of the caliper or caliper assembly 100 and portions 104 and 102 are steel front and rear of the caliper 100 and all are solidly attached to each other. Caliper 100 is a solid steel permanent caliper fixture with the piston 110 passing in and out of the caliper assembly 100 through plate 102. The piston is controlled by hydraulic pressure. When brakes in for example an automobile, are applied, the piston 110 (housed in a cylinder not shown on the caliper 100) comes out through plate 102 to push a brake pad (not shown) into a rotor assembly (not shown) to create friction necessary for stopping. Releasing the brake, causes the piston 110 to retract.

FIG. 6B shows a perspective view of the apparatus 10 of FIGS. 1-5 in the state of FIG. 3, inserted into the caliper housing 101 of FIG. 6A. In FIG. 6B the plate 83 is not touching the portion 102 and is not touching the piston 110. FIG. 6C shows a perspective view of the apparatus 10 of FIGS. 1-5 in the state of FIG. 4, inserted into the caliper housing 101 of FIG. 6A.

The apparatus 10 can be used in the single piston caliper 100 of FIGS. 6A, 6B, and 6C as follows. The pull handle or portion 21 would be placed in a horizontal position, substantially parallel to the bottom 104b of the U-shaped slot 104a of the caliper 100 as shown in FIG. 6B. In this position the longest side of the push plate 83 will be substantially perpendicular to the bottom 104b of the U-shaped slot 104a of the caliper 101. Typically for an automobile this would mean that the longest side of the plate 83 would be perpendicular to ground. In this position, either the spacer 63 or 64 (in FIG. 6B, spacer 63 is in slot 104a) will be in the U-shaped centered slot 104a of the caliper housing portion 104 as shown in FIG. 6B. The push plate 83 will be aligned with the piston 110. The portion 104 is between the wedge plate 72 and the tube plate 70.

After the apparatus 10 has been correctly positioned as in FIG. 6B, squeezing the handle portion 21 in direction A1 applies pressure to the push plate 83 which moves until eventually (after one or more squeezes) the push plate 83 contacts the piston 110 as shown in FIG. 6C. After the push plate 83 has come into contact with the piston 110, subsequent squeezes on the handle portion 21, cause pressure to be applied to the piston 110 and causes the wedge plate 72 to be forced against the caliper housing portion 104. The piston 110 is gradually forced in a direction D1 to an appropriate position. Once the piston is pushed or pressed back, the portion 13a of the quick release trigger 13 is pushed to return the push or press plate 83 to the position shown in FIG. 6B.

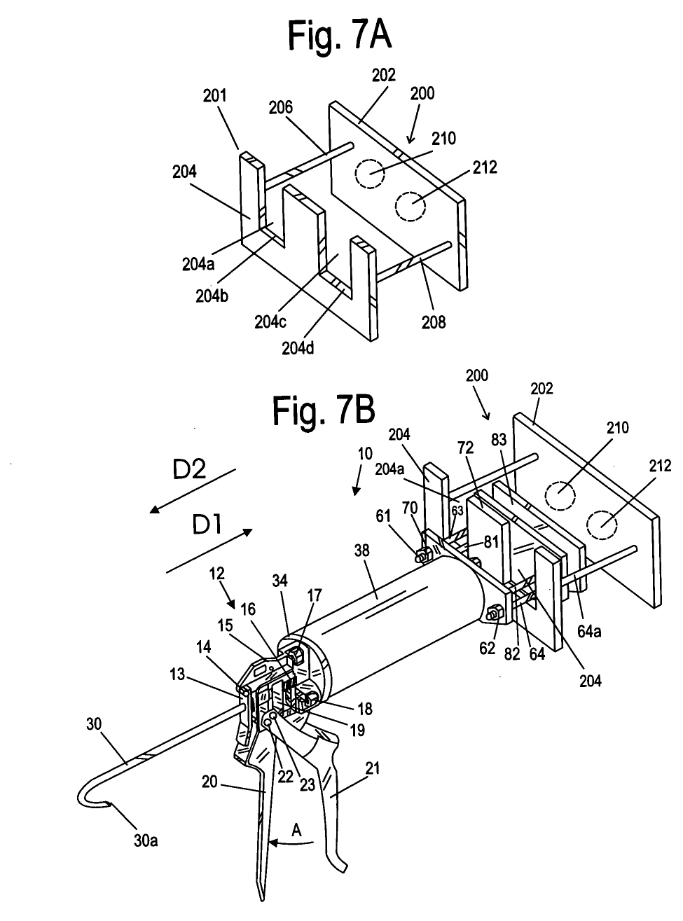

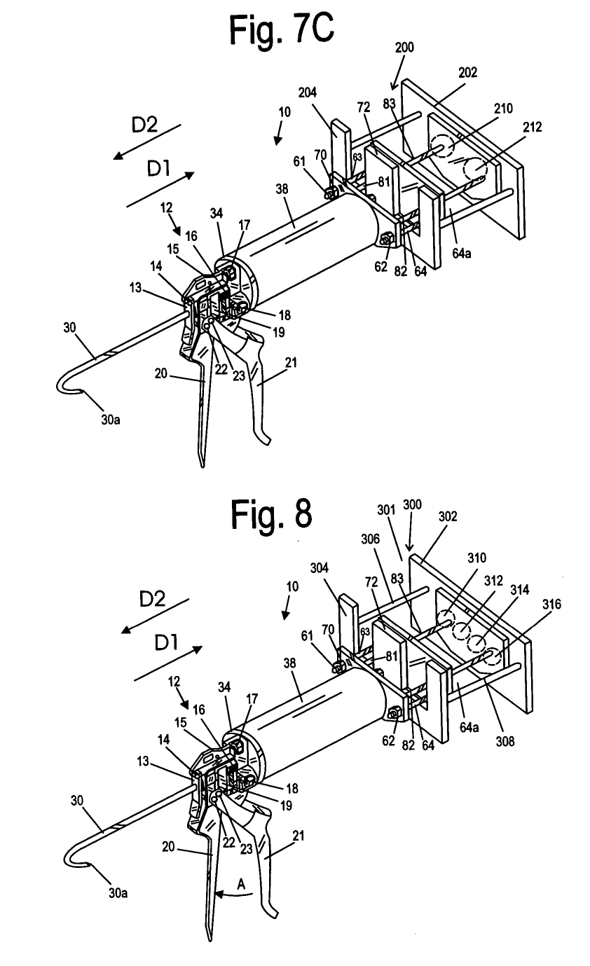

FIG. 7A shows a perspective view of a caliper or caliper assembly 200 including a caliper housing 201 which includes portions 204 and 206. FIG. 7A also shows pistons 210 and 212. The portions 204 and 202 are connected by members 206 and 208.

In FIG. 7A, members 206 and 208 represent the steel sides of the caliper or caliper assembly 200 and portions 204 and 202 are steel front and rear of the caliper 200 and all are solidly attached to each other. Caliper 200 is a solid steel permanent caliper fixture with the pistons 210 and 212 passing in and out of the caliper assembly 200 through plate 202. The piston is controlled by hydraulic pressure. When brakes in for example an automobile, are applied, the piston 210 and 212 (housed in a cylinder not shown on the caliper 200) comes out through plate 202 to push a brake pad (not shown) into a rotor assembly (not shown) to create friction necessary for stopping. Releasing the brake, causes the piston 210 and 212 to retract.

FIG. 7B shows a perspective view of the apparatus 10 of FIGS. 1-5 in the state of FIG. 3 inserted into the caliper housing 201 of FIG. 7A. FIG. 7C shows a perspective view of the apparatus 10 of FIGS. 1-5 in the state of FIG. 4 inserted into the caliper housing 201 of FIG. 7A.

To use the apparatus 10 on a double or quad piston caliper, such as 200 in FIG. 7A, the apparatus 10 is placed into a position where the handle 21 is turned to a vertical (upright) position as shown in FIGS. 7B and 7C, where the handle 21 portion is substantially perpendicular to the bottoms 204b and 204d of the U-shaped slots 204a and 204c, respectively, of the brake caliper housing 201. The spacers 63 and 64 are positioned into the dual U-shaped slots 204a and 204c, respectively, and located on the bottoms 204b and 204d of the U-shaped slots 204a and 204c, respectively. The push plate 83 will be aligned with the caliper pistons 210 and 212 in FIG. 7B and 7C. The handle 21 can be squeezed in direction A to apply pressure to the push plate 83 and wedge the wedge plate 72 into the caliper housing portion 304 thereby applying pressure to the caliper pistons 210 and 212. Once the pistons 210 and 212 are moved back, simply pressing the portion 13a of the release trigger 13 returns the press plate 83 to its starting position.

FIG. 8 shows a perspective view of the apparatus 10 of FIGS. 1-5 in the state of FIG. 4, inserted into an apparatus 300 or quadruple caliper piston 300. The quadruple caliper piston, includes caliper housing 301 which includes portions 302 and 304. The portions 302 and 304 are connected by members 306 and 308. The apparatus 300 includes pistons 310, 312, 314, and 316. The insertion and operation of the apparatus 10 in the caliper housing 301 is the same as for the double piston example of FIGS. 7A-7C.

The first (cam) plate 44, second (press or push) plate 83, third (tube) plate 70, and fourth (wedge) plate 72 can be plates that were developed and field tested under actual working conditions with caliper pistons. In order to arrive at the design for the plates 44, 83, 70, and 72 shown by FIGS. 1-5, the applicant redesigned plates several times during the research and development stage to perfect the plates. The particular shape shown for the plates 44, 83, 70, and 72 in FIGS. 1-5 accommodates virtually all disc brake calipers to include foreign and domestic applications.

All components of the apparatus 10 can be built with industrial grade materials. A case hardened steel shaft can be used for rod 30 shown in FIG. 1, grade eight push rods can be used for rods 81, 82 and bolts 63a, 64a, 65, 66, 67 shown in FIG. 2, and steel alloy springs can be used for springs 81a, 82a, 32, 24 shown in FIG. 1. The Tube housing 38 shown in FIG. 1. can be cast steel or aluminum. The tube housing 38 can be preformed tubing of aluminum or steel. The wedge plate 72, push plate 83, and cam plate 44, tube plate 70, tube cap 34, as shown in FIG. 1 can be machined steel or steel alloy. Stationary handle 20 and pull handle of portion 21 of the handle assembly 12 as seen in FIG. 7C and 8 can be cast steel, cast steel alloy or cast aluminum, with quick release trigger 13 being steel or steel alloy. Pivot pin 22 and restraining pin 23 can be cast or machined steel. Rod driver 19 can be cast or machined steel and case hardened, and can include, but is not limited to surface hardening treatments; i.e. Zirconium Nitride, Titanium Nitride, or Cobalt Nitride coatings.

The design of apparatus 10 is cost effective and allows the apparatus 10 to be easily and affordably repaired. The apparatus 10 has a spring loaded trigger release mechanism, which includes springs 81a and 82a. This spring loaded trigger release mechanism allows for one hand operation of the apparatus 10. This allows a technician to perform a task in a safer manner and also speeds up the process.

The embodiment of the current invention shown by FIGS. 1-5 incorporates a unique driving force that is distributed geometrically through the cam plate 44 and dual rod assembly, including rods 81 and 82 thereby applying equal pressure across the width of the push or press plate 83 which effectively accommodates single, dual, and quad piston calipers.

The apparatus 10 is a much stronger tool than that of the prior art. The apparatus 10 has a short case hardened single push rod 30 that's connected to the cam plate 44. The cam plate 44 in turn applies equal pressure to a dual push rod assembly, which includes rods 81 and 82, that connects from the cam plate 44 to the push or press plate 83. This results in a more stable configuration, which will not allow the push rods 30, 81, or 82 to bend or warp when under the pressure necessary to retract caliper pistons.

The apparatus 10, including the push plate 83 and wedge plate 72, was developed and tested by brake technicians on a daily basis. The particular configuration for the push plate 83 and the wedge plate 72 shown in FIGS. 1-5 is the result of several modifications made during the research, development and testing stage. This push plate 83 and wedge plate 72 combination accommodates virtually all front and rear disc brake calipers with single, double and quad piston designs.

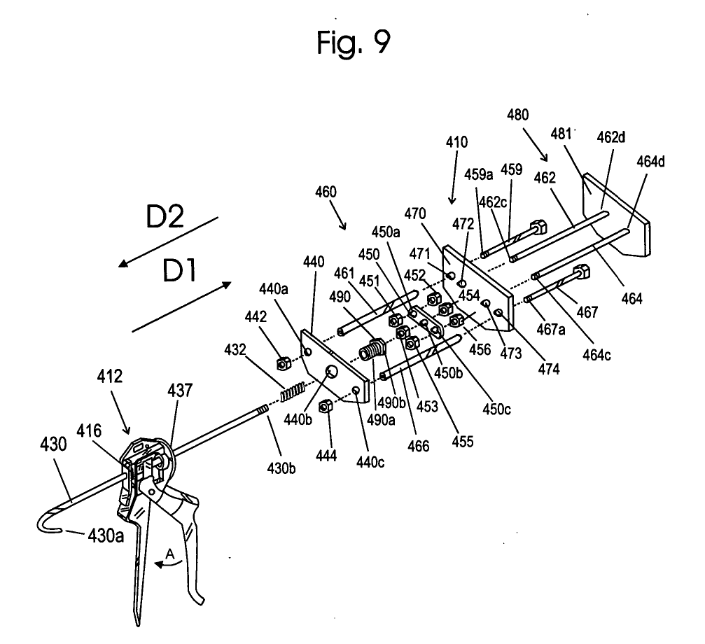

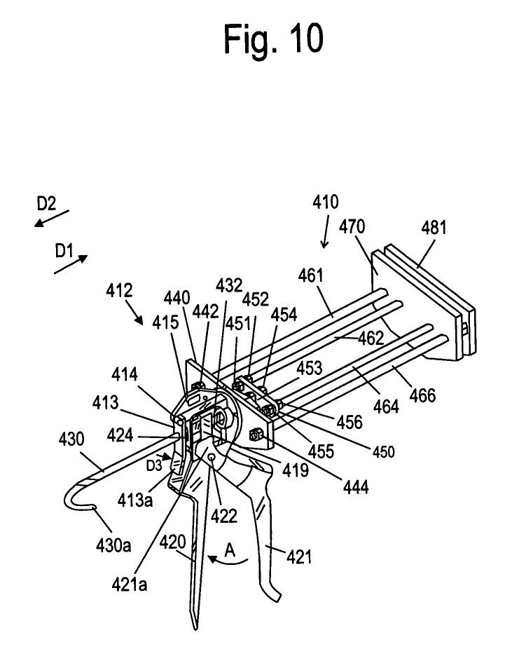

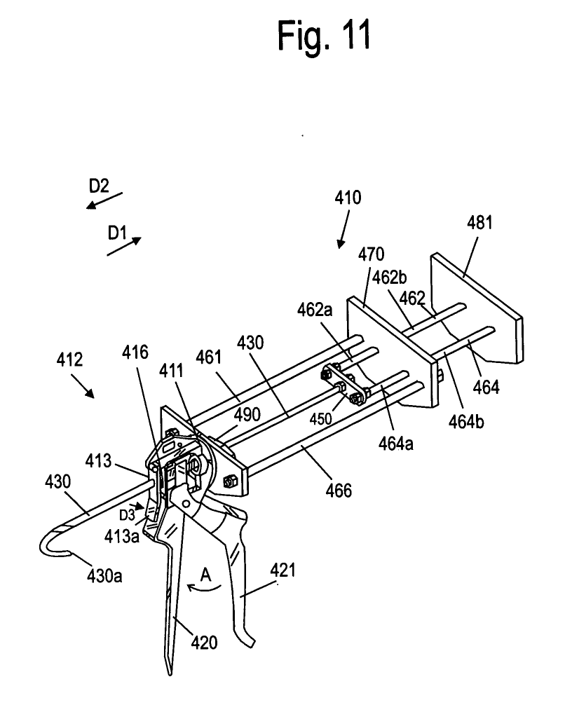

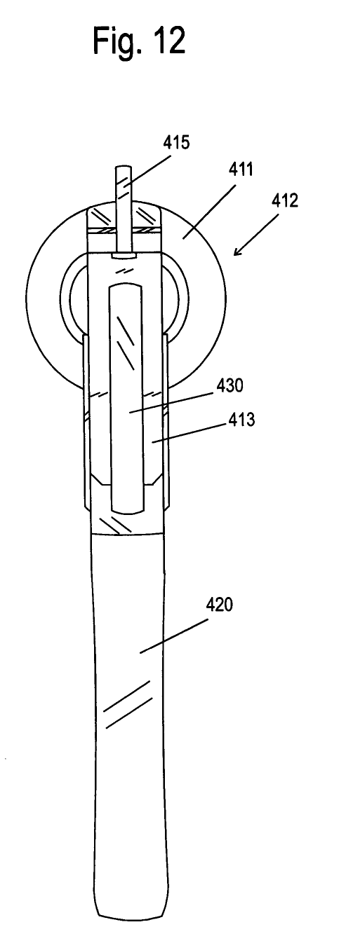

FIG. 9 shows a perspective view of an apparatus 410 in accordance with another embodiment of the present invention wherein the apparatus 410 has been, at least partially, taken apart. FIG. 10 shows a perspective view of the apparatus 410 of FIG. 9 wherein the apparatus 410 has been assembled and placed in a first or compressed state. FIG. 11 shows a perspective view of the apparatus 410 of FIG. 9 wherein the apparatus 410 has been assembled and placed in a second or expanded state. FIG. 12 shows a front view of a push rod and handle assembly, which are part of the apparatus 410 of FIG. 9.

Referring to FIG. 9, the apparatus 410 is comprised of a push rod 430, a handle assembly 412, a cam plate or member plate 440, a spacer assembly 460, and a push plate assembly 480.

A spring 432 is placed on the push rod 430. The push rod 430 ends in a loop at end 430a and has threads at end 430b.

The handle assembly 412 is shown in further detail in FIGS. 10 and 12. The handle assembly 412 includes release trigger lever 413, member 414, member 415, and spring 416. The handle assembly 412 of FIGS. 9-12 is similar to the handle assembly 12 of FIGS. 1-5 with some exceptions. The handle assembly 412 does not include pockets or seats like pockets or seats 17a, 17b, and 17c for handle assembly 12 of FIG. 1.

The handle assembly 412, as shown in FIG. 10, also includes rod driver 419, stationary handle 420, and pull handle or portion 421, pivot pin 422, and spring 424.

Referring to FIG. 9, the spacer assembly 460 includes a plate 440, and a wedge plate 470. The spacer assembly 460 also includes bolts 459 and 467, spacers 461 and 466, nuts 442 and 444, plate 450, nuts 451, 453, and 455, nuts 452, 454, and 456, and hollow bolt 490.

The push plate assembly 480 includes push plate 481, push rods 462 and 464. The push rods 462 and 464 have threads at ends 462c and 464c. The push rods 462 and 464 are fixed to the push plate 481 at ends 462d and 464d.

The apparatus 410 can be assembled in the following manner. Spring 432 can be placed on the push rod 430 by inserting end 430b through the spring 432. The end 430b can then be inserted through an opening 440b in plate 440. The hollow bolt 490 can then be placed on the end 430b of the push rod 430. A threaded portion 490a of the hollow bolt 490 is screwed into a circular threaded opening 437 of the handle assembly 412 to secure the plate 440 to the handle assembly 412.

Next the threaded ends 459a and 467a of the bolts 459 and 467 can be inserted through the openings 471 and 474 of the plate 470 and then through the hollow tubes or spacers 461 and 466, respectively. Next the threaded ends 459a and 467a of the bolts 459 and 467 can be inserted through openings 440a and 440c, respectively of the plate 440. Nuts 442 and 444 are screwed onto the ends 459a and 467a, respectively to secure the plate 470 to the plate 440.

Next the threaded ends 462c and 464c of the bolts 462 and 464 are inserted through openings 472 and 473, respectively of the plate 470. The threaded ends 462c and 464c are next inserted through nuts 452 and 456, and next through openings 450a and 450c of the plate 450, respectively. Then the nuts 451 and 455 are screwed onto the threaded ends 462c and 464c and tightened to secure the bolts 462 and 464 (and thus the plate 481) to the plate 450.

Finally, the plate 450 is secured to the push rod 430 by inserting the end 430b through the nut 453, then through the opening 450b in the plate 450 and then screwing the bolt 454 onto the end 430b.

After the apparatus 410 has been assembled, as in FIG. 10 or FIG. 11, the apparatus 410 can be placed in either the state of FIG. 10 or FIG. 11. In accordance with an embodiment of the present invention, the apparatus 410 can be used for the purpose of retracting single, double, or quadruple caliper pistons.

The apparatus 410 would typically be first placed in the state shown in FIG. 10 where the press plate 481 is pressing against or closely adjacent to the hex heads of the spacer bolts 459 and 467. The press plate 481 can gradually be forced to move in a direction D1 away from the wedge plate 470, from the position or state of FIG. 10 to the position or state of FIG. 11, by squeezing portion 421 of the handle assembly 412, to make portion 421 pivot toward, in a direction A, toward portion 420. The portion 421 pivots about axis or pin 422. The squeezing and/or pivoting of portion 421 causes top portion 421a, shown in FIG. 10, to deflect and push portion 419. Portion 419, in response, frictionally grips onto push rod 430 and pushes push rod 430 forward in the direction D1. With each squeeze or pivot of the portion 421, the push rod 430 moves in the direction D1 causing the push plate 481 to also move in the direction D1. The push rod 430 can be moved in the direction D1 with each pivot of the portion 421 in the direction A shown in FIG. 10, until the end 430a of the push rod 430 comes in contact with the portion 413 of the handle assembly. At that time, the apparatus 410 is in its fully extended state, shown in FIG. 11. In the state shown in FIG. 11, portions 462a and 464a of the bolts or rods 462 and 464 respectively, are on one side of the plate 470 while portions 462b and 464b are on the other side of the plate 470.

The apparatus 410 can be easily changed from the state in FIG. 11 back to the state in FIG. 10, by pressing on portion 413a, shown in FIGS. 10 and 11, of the release trigger 413 in the direction D3, shown in FIG. 11. Pressing on portion 413a of the release trigger 413 presses on spring 424 of the handle assembly 412, causing push rod 430 to be released from being restrained by rod driver 419 and spring 432, thereby releasing solid pressure applied to push rods 462, 464, and plates 450, 470, and 481. Released pressure creates recoil on plate 481 in direction D2 thereby allowing removal of apparatus 410 from the caliper housing 200.

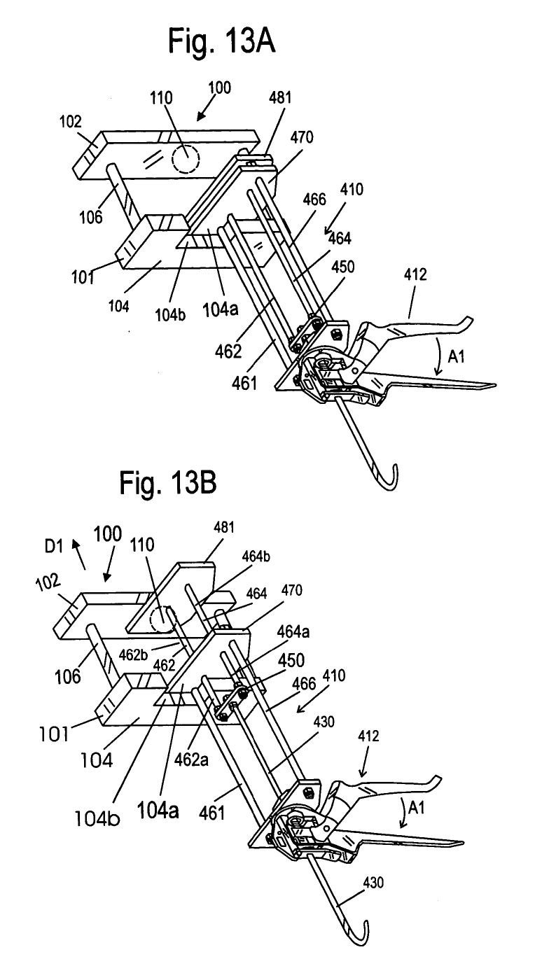

FIG. 13A shows a perspective view of the apparatus 410 of FIGS. 9-12 in the state of FIG. 10, inserted into the caliper housing 101 of FIG. 6A. In FIG. 13A the plate 481 is not touching the portion 102 and is not touching the piston 110. FIG. 13B shows a perspective view of the apparatus 410 of FIGS. 9-12 in the state of FIG. 11, inserted into the caliper housing 101 of FIG. 6A.

The apparatus 410 can be used in the single piston caliper 100 as shown by FIGS. 13A and 13B as follows. The pull handle or portion 421 would be placed in a horizontal position, substantially parallel to the bottom 104b of the U-shaped slot 104a of the caliper 100 as shown in FIG. 13A. In this position the longest side of the push plate 481 will be substantially perpendicular to the bottom 104b of the U-shaped slot 104a of the caliper 101. Typically for an automobile this would mean that the longest side of the plate 481 would be perpendicular to ground. In this position, either the spacer 461 or 466 (in FIG. 13A, spacer 461 is in slot 104a) will be in the U-shaped centered slot 104a of the caliper housing portion 104 as shown in FIG. 13A. The push plate 481 will be aligned with the piston 110. The portion 104 is between the wedge plate 470 and the plate 450.

After the apparatus 410 has been correctly positioned as in FIG. 13A, squeezing the handle portion 421 in direction Al applies pressure to the push plate 481 which moves until eventually (after one or more squeezes) the push plate 481 contacts the piston 110 as shown in FIG. 13B. After the push plate 481 has come into contact with the piston 110, subsequent squeezes on the handle portion 421, cause pressure to be applied to the piston 110 and cause the wedge plate 470 to be forced against the caliper housing portion 104. The piston 110 is gradually forced in a direction D1 to an appropriate position. Once the piston 110 is pushed or pressed back, the portion 413a of the quick release trigger 413 is pushed to return the push or press plate 481 to the position shown in FIG. 13A.

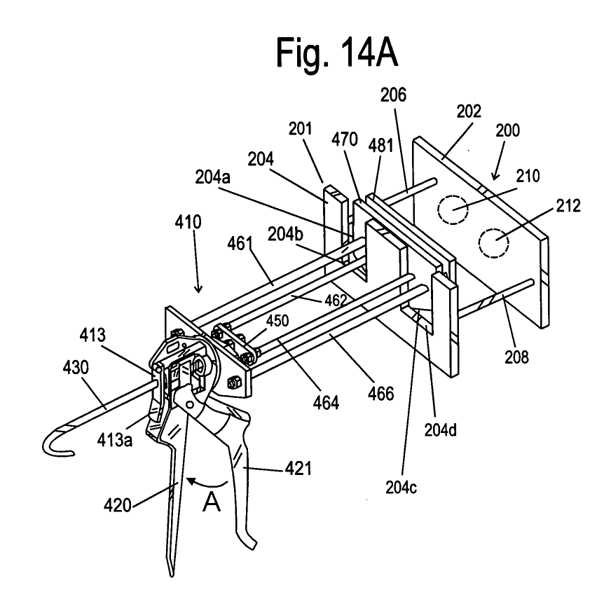

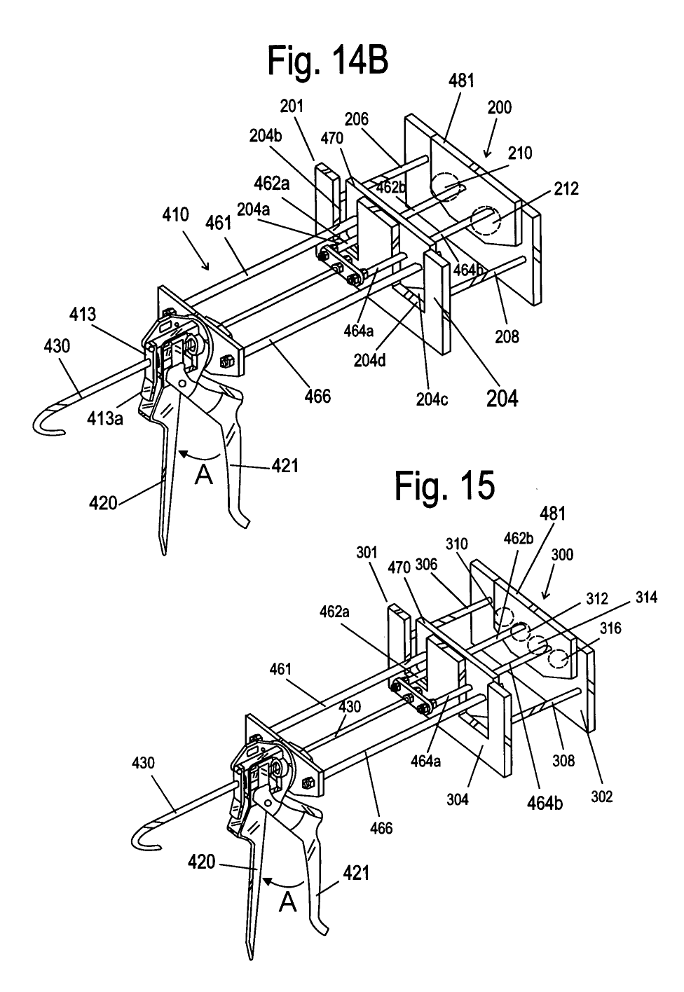

FIG. 14A shows a perspective view of the apparatus 410 of FIGS. 9-12 in the state of FIG. 10 inserted into the caliper housing 201 of FIG. 7A. FIG. 14B shows a perspective view of the apparatus 410 of FIGS. 9-12 in the state of FIG. 11 inserted into the caliper housing 201 of FIG. 7A. To use the apparatus 410 on a double or quad piston caliper, such as 200 in FIG. 7A, the apparatus 410 is placed into a position where the handle 421 is turned to a vertical (upright) position as shown in FIGS. 14A and 14B, where the handle 421 portion is substantially perpendicular to the bottoms 204b and 204d of the U-shaped slots 204a and 204c, respectively, of the brake caliper housing 201. The spacers 461 and 466 are positioned into the dual U-shaped slots 204a and 204c, respectively, and located on the bottoms 204b and 204d of the U-shaped slots 204a and 204c, respectively. The push plate 481 will be aligned with the caliper pistons 210 and 212 in FIG. 14A and 14B. The handle 421 can be squeezed in direction A to apply pressure to the push plate 481 and wedge the wedge plate 470 into the caliper housing portion 204 thereby applying pressure to the caliper pistons 210 and 212. Once the pistons 210 and 212 are moved back, simply pressing the portion 413a of the release trigger 413 to release pressure applied to plate 481 and 470 and allow removal of apparatus 410 from the caliper housing 200.

FIG. 15 shows a perspective view of the apparatus 410 of FIGS. 9-12 in the state of FIG. 11, inserted into an apparatus 300 or quadruple caliper piston 300. The quadruple caliper piston, includes caliper housing 301 which includes portions 302 and 304. The portions 302 and 304 are connected by members 306 and 308. The apparatus 300 includes pistons 310, 312, 314, and 316. The insertion and operation of the apparatus 10 in the caliper housing 301 is the same as for the double piston example of FIGS. 14A-B.

The plates 440, 450, 470, and 481 can be plates that were developed and field tested under actual working conditions with caliper pistons. In order to arrive at the design for the plates 440, 450, 470, and 481 shown by FIGS. 9-12, the applicant redesigned plates several times during the research and development stage to perfect the plates. The particular shape shown for the plates 440, 450, 470, and 481 in FIGS. 9-12 accommodates virtually all disc brake calipers to include foreign and domestic applications.

All components of the apparatus 410 can be built with industrial grade materials. A case hardened steel shaft can be used for rod 430. Grade eight push rods can be used for rods or bolts 462 and 464 an bolts 459 and 467 shown in FIG. 9, and steel alloy springs can be used for springs 424 and 432. The plates 440, 450, 470, and 481 can be machined steel or steel alloy. Stationary handle 420 and pull handle of portion 421 of the handle assembly 412 as seen in FIGS. 9 and 10 can be cast steel, cast steel alloy or cast aluminum, with quick release trigger 413 typically being steel or steel alloy. Pivot pin 422 can be cast or machined steel. Rod driver 419 can be cast or machined steel and case hardened, and can include, but is not limited to surface hardening treatments; i.e. Zirconium Nitride, Titanium Nitride, or Cobalt Nitride coatings.

The design of the apparatus 410 is cost effective and allows the apparatus 410 to be easily and affordably repaired.

The embodiment of the current invention shown by FIGS. 9-12 incorporates a handle assembly 412 that applies a driving force with push rod 430 connected to plate 450, which geometrically distributes the driving force to a dual push rod assembly attached to plate 450, comprised of rods or bolts 462 and 464 attached to press plate 481. The dual push rod assembly thereby applies equal pressure across the width of the push or press plate 481, which effectively accommodates single, dual, and quad piston calipers.

The apparatus 410 may have a short case hardened single push rod 430 that's connected to the plate 450. The plate 450 in turn applies equal pressure to a dual push rod assembly, which includes rods 462 and 464, that connects from the plate 450 to the push or press plate 481. This results in a stable configuration, which will not allow the push rods 30, 462, or 464 to bend or warp when under the pressure necessary to retract caliper pistons.

The push plate 481 and wedge plate 470 combination accommodates virtually all front and rear disc brake calipers with single, double and quad piston designs.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising
a first rod;
a second rod; and
a third rod;
a first plate;
wherein the first rod is connected at a first end to the second and third rods so that when the first rod moves the second and third rods also moves;
wherein the first rod slides through an opening in the first plate;
and wherein the first plate is connected to a handle assembly by a hollow bolt through which the first rod slides.

2. The apparatus of claim 1 further comprising
a second plate; and
wherein the first rod is connected at its first end to the second plate and the second and third rods each have a first end, which is connected to the second plate.

3. The apparatus of claim 2 further comprising
a third plate; and
wherein the second and third rods each have a second end, which is connected to the third plate.

4. The apparatus of claim 3 further comprising
a fourth plate; and
wherein the first plate is connected to the fourth plate by first and second members, so that the first plate is at a fixed distance with respect to the fourth plate;
and wherein the second and third rods can slide through first and second openings, respectively, of the fourth plate.

5. A method comprising:
placing an apparatus in a first state;
placing the apparatus onto a caliper piston of an automobile;
pressing back the caliper piston with the apparatus; and
removing the apparatus from the caliper piston; and
wherein the apparatus includes a first rod, a second rod, a third rod, a first plate, and a handle assembly, and wherein the first rod is connected at a first end to the second and third rods so that when the first rod moves the second and third rods also moves;
wherein the first rod slides through an opening in the first plate;
and wherein the first plate is connected to the handle assembly by a hollow bolt through which the first rod slides;
and wherein the movement of the first, second, and the third rods is used to press back the caliper piston.

6. The method of claim 5 wherein
the caliper piston is a double caliper piston.

7. The method of claim 5 wherein
the caliper piston is a single caliper piston.

8. The method of claim 5 wherein
the apparatus includes a second plate, wherein the second plate is connected to the second rod and the third rod; and
wherein the second plate comes in contact with and presses against the caliper piston to press back the caliper piston.

9. The method of claim 8 wherein
the apparatus includes a third plate, wherein the second and the third rod slide through first and second openings of the third plate, respectively, in order to press back the caliper piston.

10. The method of claim 9 wherein
the apparatus includes first and second spacers; and
wherein the first and second spacers space the first and third plates a fixed distance away from each other.
